(19) United States
(12) Patent Application Publication
(10) Pub. No.: US 2018/0368105 A1
(43) Pub. Date: Dec. 20, 2018

(54) Method and Apparatus for Implementing Autonomous Determination of Uplink Resources by User Equipment

(71) Applicant: Nokia Solutions and Networks Oy, Espoo (FI)

(72) Inventors: Frank FREDERIKSEN, Klarup (DK); Claudio ROSA, Randers (DK)

(21) Appl. No.: 15/781,748

(22) PCT Filed: Dec. 6, 2016
(86) PCT No.: PCT/EP2016/079806

§ 371 Date: Jun. 6, 2018

Related U.S. Application Data
(60) Provisional application No. 62/264,668, filed on Dec. 8, 2015.

(51) Int. Cl. H04W 72/02; H04W 48/10; H04W 72/00; H04W 72/04; H04L 1/18

(52) U.S. Cl. CPC H04W 72/02; H04W 48/10; H04L 5/005; H04W 72/0446; H04L 1/1887; H04W 72/005

(57) ABSTRACT

A method and apparatus for use in a LTE unlicensed spectrum standalone deployment (e. g., MulteFire Alliance) may include determining, by a user equipment, that a radio channel is unoccupied by other user equipment. Determining that the radio channel is unoccupied includes determining a lack of downlink transmission on the radio channel. The method may also include determining resources for performing uplink transmissions. The resources are determined autonomously by the user equipment. The method may also include performing an uplink transmission using the determined resources.

### BACKGROUND

### Field

Certain embodiments of the present invention relate to implementing autonomous determination of uplink resources by user equipment, for the transmission of uplink control information and for the transmission of random access preambles in unlicensed spectrum.

### Description of the Related Art

Long-term Evolution (LTE) is a standard for wireless communication that seeks to provide improved speed and capacity for wireless communications by using new modulation/signal processing techniques. The standard was proposed by the 3^{rd} Generation Partnership Project (3GPP), and is based upon previous network technologies. Since its inception, LTE has seen extensive deployment in a wide variety of contexts involving the communication of data.

### SUMMARY

According to a first embodiment, a method may include determining, by a user equipment, that a radio channel is unoccupied by other user equipment. Determining that the radio channel is unoccupied may include determining a lack of downlink transmission on the radio channel. The method may also include determining resources for performing uplink transmissions. The resources may be determined autonomously by the user equipment. The method may also include performing an uplink transmission using the determined resources.

In the method of the first embodiment, the performing the uplink transmission comprises performing the uplink transmission on an unlicensed spectrum.

In the method of the first embodiment, the determining the resources comprises determining physical random access channel resources.

In the method of the first embodiment, the performing the uplink transmission comprises transmitting a random access preamble.

In the method of the first embodiment, the determining that the radio channel is unoccupied is based on at least one of a presence of a primary synchronization signal, a presence of a secondary synchronization signal, a cell-specific reference signal, a physical broadcast channel, and an enhanced system information block.

According to a second embodiment, an apparatus may include at least one processor. The apparatus may also include at least one memory including computer program code. The at least one memory and the computer program code may be configured, with the at least one processor, to cause the apparatus at least to determine that a radio channel is unoccupied by other user equipment. Determining that the radio channel is unoccupied comprises determining a lack of downlink transmission on the radio channel. The apparatus may also be caused to determine resources for performing uplink transmissions, wherein the resources are determined autonomously by the apparatus. The apparatus may also be caused to perform an uplink transmission using the determined resources.

In the apparatus of the second embodiment, the performing the uplink transmission comprises performing the uplink transmission on an unlicensed spectrum.

In the apparatus of the second embodiment, the determining the resources comprises determining physical random access channel resources.

In the apparatus of the second embodiment, the performing the uplink transmission comprises transmitting a random access preamble.

In the apparatus of the second embodiment, the determining that the radio channel is unoccupied is based on at least one of a presence of a primary synchronization signal, a presence of a secondary synchronization signal, a cell-specific reference signal, a physical broadcast channel, and an enhanced system information block.

According to a third embodiment, a computer program product may be embodied on a non-transitory computer readable medium. The computer program product may be configured to control a processor to perform a method. The method may include determining, by a user equipment, that a radio channel is unoccupied by other user equipment. Determining that the radio channel is unoccupied comprises determining a lack of downlink transmission on the radio channel. The method may also include determining resources for performing uplink transmissions. The resources may be determined autonomously by the user equipment. The method may also include performing an uplink transmission using the determined resources.

### BRIEF DESCRIPTION OF THE DRAWINGS

For proper understanding of the invention, reference should be made to the accompanying drawings, wherein:

FIG. 1 illustrates a configuration used by certain embodiments of the present invention.

FIG. 2 illustrates a flowchart of a method in accordance with certain embodiments of the invention.

FIG. 3 illustrates an apparatus in accordance with certain embodiments of the invention.

FIG. 4 illustrates an apparatus in accordance with certain embodiments of the invention.

### DETAILED DESCRIPTION

Certain embodiments of the present invention relate to implementing autonomous determination of uplink time resources by user equipment, for the transmission of uplink control information and transmission of random access preambles in unlicensed spectrum.

Release 13 LTE Licensed Assisted Access (LAA) provides licensed-assisted access to an unlicensed spectrum. The licensed-assisted access may be provided to a user equipment that uses technology that coexists with other technologies, while also fulfilling the relevant regulatory requirements. With Release 13 LTE LAA, an unlicensed spectrum may be accessed/utilized in order to improve LTE Downlink (DL) throughput. One or more LAA DL Secondary Cells (Scell) may be configured to a user equipment (UE) as a part of DL Carrier Aggregation (CA) configuration, while a corresponding Primary Cell (Pcell) may be on a licensed spectrum.

Certain groups have recently initiated discussions regarding the possibility of extending LAA for use by standalone LTE operations on unlicensed spectrum. LTE standalone operation on unlicensed spectrum generally means that an air interface between an evolved Node B and a User Equipment relies solely on unlicensed spectrum, without using any anchor carrier on a licensed spectrum. The efforts of certain parties have recently resulted in the formation of the MulteFire Alliance.

As compared to LTE LAA, one requirement associated with LTE standalone deployment (on an unlicensed spectrum) relates to the need to support random access procedures within the unlicensed spectrum. With LTE LAA, random access procedures are mainly supported through the licensed spectrum.

Discussions related to MulteFire Random Access Channel (RACH) and Physical Random Access Channel (PRACH) resources have focused on access methodology and procedures, and fewer efforts have been directed to determining the time-wise availability of the physical resources for the PRACH transmission (or, more accurately, the time-wise availability of resources that are used for the transmission of random access preambles). The random access preambles are used by the UE to contact the eNB, in order to initiate communication between the UE and the eNB. This communication is typically needed at the time of initial access and at handover. In view of the above, with certain embodiments, an eNB may act as a scheduling node, where eNB transmissions may determine uplink transmissions, and where uplink transmissions may possibly not occur without the scheduling by the eNB.

When operating in an unlicensed band, one of the preconditions for the operation is that a channel should be detected/sensed by the UE, prior to accessing the radio channel. With MulteFire (and with any other system that operates in typical WiFi bands), the channel detecting/sensing may be implemented through “Clear channel assessment” (CCA) or “Listen-before-talk” (LBT) procedures. As such, transmissions will occur after the UE has determined that the channel is not occupied by other devices.

With MulteFire, the current approach uses a special subframe to configure the PRACH resources that used for transmitting the random access preamble. The special subframe used for MulteFire is, to a large extent and on a conceptual level, similar to what is defined for other Time-Division-Duplex (TDD) related systems (such as Time-Division-LTE (TD-LTE) systems, for example) to facilitate switching between downlink transmissions and uplink transmissions. Downlink transmissions correspond to transmissions from the eNB to the UE, and uplink transmissions correspond to transmissions from the UE to the eNB.

In order to establish the special subframe, the scheduling node (in this case, the eNB) performs an initial transmission of subframes with scheduling information, such that any UEs that are listening to the eNB can identify a frame timing and may also identify the location of the special subframe, such that the PRACH resources are also configured/defined. With MulteFire, this approach may be referred to as dynamic PRACH.

Another possible way to configure/provide physical resources for the transmission of random access preambles is by configuring periodic resources (i.e., resources that are fixed in time) via broadcasting of system information. With MulteFire, this approach is referred to as periodic PRACH.

One technical difficulty with the above approaches is that dynamic PRACH resources are generally only available when the corresponding eNB is also scheduling data in either downlink or uplink. In the event that the eNB is not transmitting any data, the UE may need to solely rely on periodic PRACH resources that are configured via broadcasting of system information. Therefore, in order to limit the random access delay that results from no data transmission, the eNB may need to configure periodic PRACH resources rather frequently (e.g., once every radio frame of 10 ms).

Frequently configuring periodic PRACH resources may limit the UL/DL flexibility when the corresponding eNB has data to schedule, because the special subframe (also containing physical RACH resources) is typically used to switch between DL and UL transmission burst during the eNB transmission opportunity. With predefined switching points in each frame or transmission opportunity, there is generally no possibility to adjust the amount of subframes assigned to downlink and uplink transmissions, respectively.

In current systems that operate in licensed bands (like Wideband Code Division Multiple Access (WCDMA), Global System for Mobile Communications (GSM), or LTE), the underlying assumption is that the operator has unlimited access to the used spectrum. This assumption allows for strict definitions regarding the availability of PRACH resources. For instance, in LTE, the operator may reserve some dedicated physical resources that may be used by the UE to transmit random access preambles, and these resources may be configured through system information broadcast. After acquiring system information, the UE can identify the time (and potentially the frequency) for transmitting its random access preamble. At the other end of the radio link, at the eNB, the eNB may constantly scan the radio channel for possible random access preambles, thereby having the means to establish the needed communication link.

As explained above, one problem with the previous approaches is that, with periodic PRACH, the eNB may need to configure periodic PRACH resources frequently, in order to limit the random access delay in situations where the eNB has no data to schedule in either uplink or downlink. However, in case of data transmission, the use of fixed (in time) UL resources (that are reserved for the transmission of random access preambles) may limit the UL/DL flexibility.

In view of the above-described technical difficulties, certain embodiments of the present invention may be directed to a method that allows a UE to autonomously determine resources for performing uplink transmissions, for radio frames which are lacking downlink transmissions. The determination may be made in order to establish traditional uplink and special subframes. Certain embodiments of the present invention facilitate uplink transmissions in the system without explicit support from downlink transmissions in the same radio frame.

With certain embodiments, if a UE detects/senses that there is a lack of downlink transmissions, the UE may establish its own default understanding of the availability of uplink transmission resources. If the UE is targeted for transmission of a random access preamble, the UE will transmit the preamble within PRACH resources that are identified by the UE, as described in more detail below. If the UE is targeted for regular transmission of uplink data (via a PUSCH) while being scheduled from an earlier radio frame, the UE will transmit in accordance with a timing identified by the UE, as described in more detail below. If the UE is intended for transmission of uplink control information related to downlink data transmission (for example, Hybrid Automatic Request (HARQ) Ack/Nack signaling), the UE will, in a similar way, identify the resources and perform the uplink transmission, as described in more detail below. If the UE is targeted for transmission of periodic uplink control transmission (such as transmission of a Sounding Reference Signal (SRS) and/or Channel State Information (CSI), for example), the UE will act in a similar way for uplink transmissions, as described in more detail below.

In order to identify/determine the available uplink resources, the UE may determine the timing of uplink transmissions based on one or more of the conditions described below. The UE may determine the timing of the uplink transmissions based on signalled values which have been received as parameters in system broadcast information. The UE may also determine the timing of the uplink transmission based on frame and subframe timing that is obtained from Discovery reference signals (DRS), which have been transmitted from the eNB at regular time intervals (but still being subject to Clear Channel Assessment (CCA)). The UE may also determine the timing of the uplink transmissions based on a subframe offset into the “empty” radio frame for a start of uplink transmissions. The UE may also determine the timing of the uplink transmission based on a Symbol offset into the specified subframe for a start of uplink transmissions. The UE may also determine the timing of the uplink transmissions based on standardization default values for these offsets. With certain embodiments, the eNB may establish a similar coordination/understanding of when the UE will potentially transmit uplink data. This coordination/understanding may ensure that the eNB is coordinated with the UE, and that the eNB will listen for the uplink transmissions at designated time instances.

In order to determine a lack of downlink transmission, the UE may determine that a downlink transmission is lacking based on one or more of the following. The UE may determine that a downlink transmission is lacking based on whether a Primary Synchronization Signal (PSS) is present. The UE may determine that a downlink transmission is lacking based on whether a Secondary Synchronization Signal (SSS) is present. The UE may determine that a downlink transmission is lacking based on cell-specific Reference Signals (CRS). The UE may also determine that a downlink transmission is lacking based on a Physical Broadcast Channel (PBCH), where the PBCH may contain a master information block (MIB). The UE may determine that a downlink transmission is lacking based on an enhanced system information block (eSIB), which may provide basic system information for accessing the system.

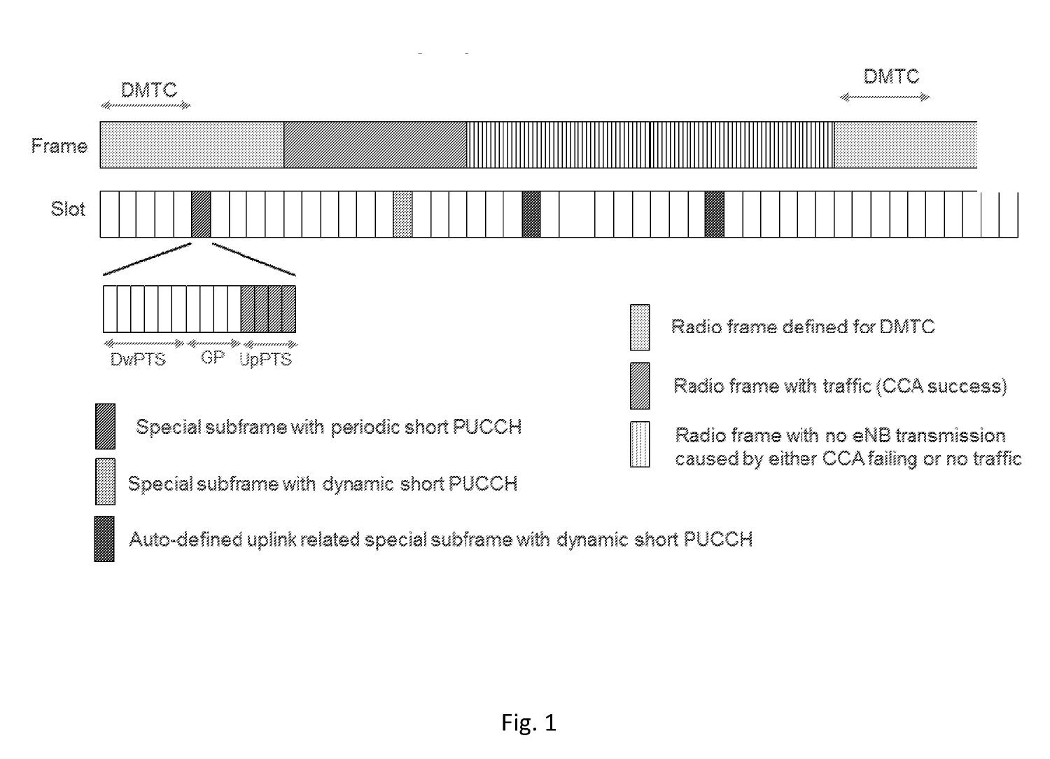

FIG. 1 illustrates a configuration used by certain embodiments of the present invention. FIG. 1 illustrates the principle behind certain embodiments of the present invention, where the time-line of a targeted MulteFire system is shown.

Referring to FIG. 1, in the first line, a frame structure is shown, and each of the radio frames may have a duration of 10 ms. Each of the radio frame transmissions may be subject to a Clear channel assessment (CCA) procedure. As such, there can be four basic operation modes of a radio frame. A first basic operation mode of a radio frame may be a Discovery Measurement Timing Configuration (DMTC) based radio frame, which describes the radio frames where the eNB will target transmission of the discovery reference sequences (DRS) and system information for basic operation. These frames are marked with light grey. A second basic operation mode of a radio frame may be a radio frame with traffic. These radio frames may contain data whenever there is traffic in the cell, and the frame may be split into three parts: (a) the downlink subframes, (b) the special subframe, and (c) the uplink subframes. The division of these resources may be quite similar to the TDD configurations used for TD-LTE. These radio frames are marked with dark grey and will be present in case of successful CCA. A third basic operation mode of a radio frame may be radio frames with no eNB transmission, due to CCA failing. A fourth basic operation mode of a radio frame may be radio frames with no eNB transmission, due to no data transmission expected in either downlink or uplink. Both the third and fourth basic operation modes are marked with vertical lines in the figure, and both are similar from a UE point of view.

Certain embodiments of the present invention are directed to the shaded frames where there is no DL transmissions from the eNB. The UE may be expected to have means to detect an absence of the downlink transmissions such that it is possible to determine whether there is a possibility for the UE to use uplink transmission possibilities. These potential uplink transmission possibilities may be referred to as “auto-defined uplink related subframes,” which may be used to perform uplink transmissions, even though downlink subframes might be absent.

As described above, the exact timing for the potential uplink transmissions can be derived in a number of ways, but, with certain embodiments of the present invention, there may be a common understanding between the UE and the eNB regarding whether the radio frame is without a DL transmission. In the event that the radio frame is without a DL transmission, the eNB will have the possibility and freedom to listen for uplink transmissions, which can be one or more of the elements described above.

Upon establishment of timing for a potential uplink transmission, the UE will perform a CCA procedure to validate the availability of the radio channel for the transmission of the needed data. In case the CCA procedure does not validate the availability of the radio channel for the transmission, the UE may either omit transmission or may attempt uplink transmission at a later (defined) time.

The eNB may also know the timing of these potential uplink transmissions and may be able to perform the needed reception (the eNB will generally be idle due to the negative Listen-Before-Talk procedure at its end).

In certain specific cases, the eNB may omit transmission of DRS due to the non-existence of traffic in the cell, but that should not prevent UEs to attempt random access preamble transmission (or regular uplink control information like CSI transmission). With certain embodiments, the eNB may know/understand the time instances where the UE may potentially transmit.

In one possible implementation of certain embodiments, the eNB may configure periodic Physical Uplink Control Channel (PUCCH) resources for the transmission of (among other uplink control information) Physical Random Access Channel (PRACH) preambles in every radio frame, such as, for example, for every 10 ms.

If the UE does not detect data transmission from the corresponding eNB in the subframes immediately preceding the periodic Physical Uplink Control Channel (PUCCH) resources, the UE may transmit on the periodic PUCCH resources (where the transmission is conditional on the results of the clear channel assessment).

If the UE detects data transmission from the corresponding eNB in the subframes immediately preceding the periodic PUCCH resources, the UE is also informed (informed via, for example, a Physical Downlink Control Channel (PDDCH)) on the exact timing of the special subframe used by the eNB to switch from DL to UL (which also includes PUCCH/PRACH resources). This timing may or may not be the same as the timing of the periodic PUCCH resources.

In case the timing of the special subframe is not the same as the timing of the periodic PUCCH resources, the UE uses PUCCH resources allocated in the special subframe and is not allowed to use periodic PUCCH resources in the corresponding radio frame.

In one embodiment of certain embodiments of the present invention, the frequency resources used by the UE for uplink transmissions in the periodic PUCCH (in the case of no scheduling from the corresponding eNB) and in the special subframe used when switching from DL transmission burst to UL transmission burst (in the case of data scheduling form the corresponding eNB) are the same.

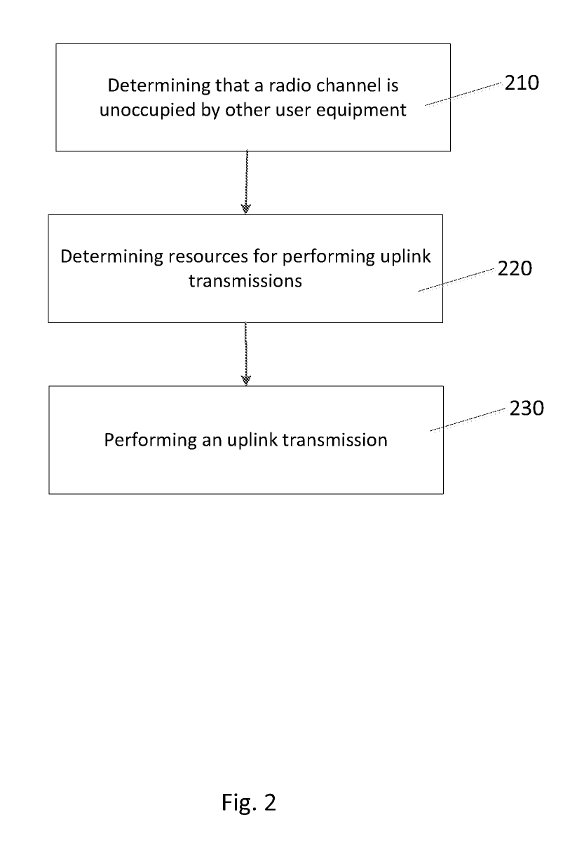

FIG. 2 illustrates a flowchart of a method in accordance with certain embodiments of the invention. The method illustrated in FIG. 2 includes, at 210, determining, by a user equipment, that a radio channel is unoccupied by other user equipment. Determining that the radio channel is unoccupied comprises determining a lack of downlink transmission on the radio channel. The method may also include, at 220, determining resources for performing uplink transmissions. The resources are determined autonomously by the user equipment. The method may also include, at 230, performing an uplink transmission using the determined resources.

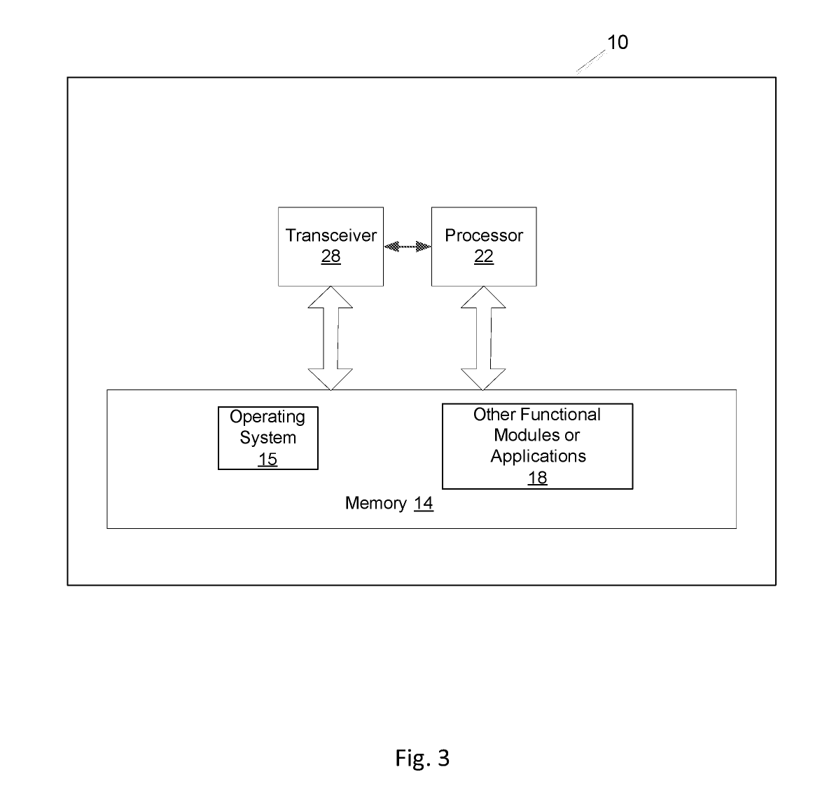

FIG. 3 illustrates an apparatus in accordance with certain embodiments of the invention. In one embodiment, the apparatus can be a network node such as an evolved Node B and/or base station, for example. In another embodiment, the apparatus may correspond to a user equipment, for example. Apparatus 10 can include a processor 22 for processing information and executing instructions or operations. Processor 22 can be any type of general or specific purpose processor. While a single processor 22 is shown in FIG. 3, multiple processors can be utilized according to other embodiments. Processor 22 can also include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 can further include a memory 14, coupled to processor 22, for storing information and instructions that can be executed by processor 22. Memory 14 can be one or more memories and of any type suitable to the local application environment, and can be implemented using any suitable volatile or nonvolatile data storage technology such as a semiconductor-based memory device, a magnetic memory device and system, an optical memory device and system, fixed memory, and removable memory. For example, memory 14 include any combination of random access memory (RAM), read only memory (ROM), static storage such as a magnetic or optical disk, or any other type of non-transitory machine or computer readable media. The instructions stored in memory 14 can include program instructions or computer program code that, when executed by processor 22, enable the apparatus 10 to perform tasks as described herein.

Apparatus 10 can also include one or more antennas (not shown) for transmitting and receiving signals and/or data to and from apparatus 10. Apparatus 10 can further include a transceiver 28 that modulates information on to a carrier waveform for transmission by the antenna(s) and demodulates information received via the antenna(s) for further processing by other elements of apparatus 10. In other embodiments, transceiver 28 can be capable of transmitting and receiving signals or data directly.

Processor 22 can perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In an embodiment, memory 14 can store software modules that provide functionality when executed by processor 22. The modules can include an operating system 15 that provides operating system functionality for apparatus 10. The memory can also store one or more functional modules 18, such as an application or program, to provide additional functionality for apparatus 10. The components of apparatus 10 can be implemented in hardware, or as any suitable combination of hardware and software.

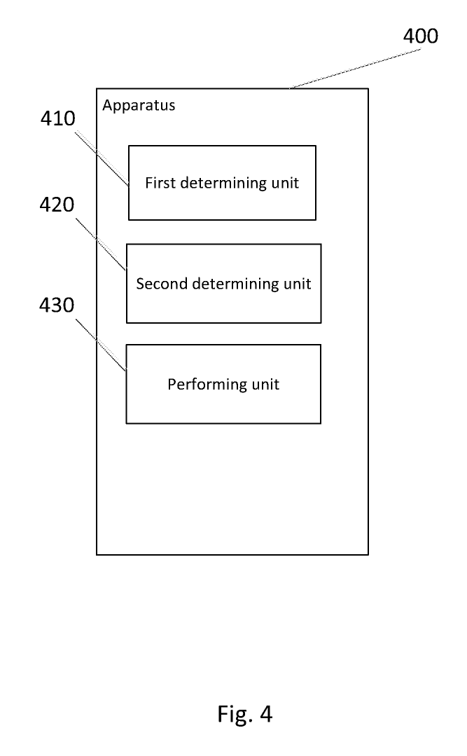

FIG. 4 illustrates an apparatus in accordance with certain embodiments of the invention. Apparatus 400 can be a user equipment, for example. Apparatus 400 can include a first determining unit 410 that determines that a radio channel is unoccupied by other user equipment. Determining that the radio channel is unoccupied comprises determining a lack of downlink transmission on the radio channel. Apparatus 400 may also include a second determining unit 420 that determines resources for performing uplink transmissions. The resources are determined autonomously by the apparatus 400. Apparatus 400 may also include a performing unit 430 that performs an uplink transmission using the determined resources.

The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1. A method, comprising:
receiving, from an access node, an acknowledgment/negative acknowledgement resource indicator in a downlink assignment, wherein the indicator corresponds to two or three resource sets; and
determining, by a user equipment, a resource for hybrid automatic repeat request acknowledgment transmission based on the acknowledgment/negative acknowledgement resource indicator and based on an outcome of a listen before talk procedure.

2. A method, comprising:
deciding a resource to be used by a user equipment for hybrid automatic repeat request acknowledgment transmission; and
indicating, by an access node, the resource using an acknowledgment/negative acknowledgement resource indicator in a downlink assignment, wherein the indicator corresponds to two or three resource sets, and wherein the indicator is configured to be considered in combination with an outcome of a listen before talk procedure.

3. The method of claim 1, wherein the indicator corresponds to two or three sets of four to eight radio resource control configured resources.

4. The method of claim 3, wherein a first set of the radio resource control configured resources is for aperiodic physical uplink control channel immediately following a downlink transmission burst.

5. The method of claim 3, wherein at least one of a second set or a third set of the radio resource control configured resources is for periodic physical uplink control channel or corresponding to physical uplink control channel resources on a carrier not configured to apply any listen before talk procedure.

6. The method of claim 1, further comprising:
determining, by the user equipment, in which subframe to transmit hybrid automatic repeat request acknowledgment, based on an outcome of a listen before talk procedure and the indicator.

7. The method of claim 1, further comprising:
determining, by the user equipment, on which carrier to transmit hybrid automatic repeat request acknowledgment, based on an outcome of a listen before talk procedure and the indicator.

8. The method of claim 1, further comprising:
determining, by the user equipment, which short physical uplink control channel format to apply, based on an outcome of a listen before talk procedure and the indicator.

9. The method of claim 1, further comprising:
determining, by the user equipment, how to determine hybrid automatic repeat request acknowledgment feedback, based on an outcome of a listen before talk procedure and the indicator.

10. The method of claim 1, further comprising:
determining, by the user equipment, which acknowledgment/negative acknowledgment resource indicator set to use, based on an outcome of a listen before talk procedure and the indicator.

11. An apparatus, comprising:
at least one processor; and
at least one memory including computer program code,
wherein the at least one memory and the computer program code are configured to, with the at least one processor, cause the apparatus at least to
receive, from an access node, an acknowledgment/negative acknowledgement resource indicator in a downlink assignment, wherein the indicator corresponds to two or three resource sets; and
determine, by a user equipment, a resource for hybrid automatic repeat request acknowledgment transmission based on the acknowledgment/negative acknowledgement resource indicator and based on an outcome of a listen before talk procedure.

12. An apparatus, comprising:
at least one processor; and
at least one memory including computer program code,
wherein the at least one memory and the computer program code are configured to, with the at least one processor, cause the apparatus at least to
decide a resource to be used by a user equipment for hybrid automatic repeat request acknowledgment transmission; and
indicate, by an access node, the resource using an acknowledgment/negative acknowledgement resource indicator in a downlink assignment, wherein the indicator corresponds to two or three resource sets, and wherein the indicator is configured to be considered in combination with an outcome of a listen before talk procedure.

13. The apparatus of claim 12, wherein the indicator corresponds to two or three sets of four to eight radio resource control configured resources.

14. The apparatus of claim 13, wherein a first set of the radio resource control configured resources is for aperiodic physical uplink control channel immediately following a downlink transmission burst.

15. The apparatus of claim 13, wherein at least one of a second set or a third set of the radio resource control configured resources is for periodic physical uplink control channel or corresponding to physical uplink control channel resources on a carrier not configured to apply any listen before talk procedure.

16.-31. (canceled)

32. A non-transitory computer-readable medium encoded with instructions that, when executed in hardware, perform a process, the process comprising the method according to claim 1.

33. A non-transitory computer-readable medium encoded with instructions that, when executed in hardware, perform a process, the process comprising the method according to claim 2.
